(19) United States
(12) Patent Application Publication
(10) Pub. No.: US 2007/0126557 A1
(43) Pub. Date: Jun. 7, 2007

(54) Method and device for contactless trasmission of data from a number of data carriers, preferably in the form of RFID-tags

(75) Inventor: Jochen Kuhn, Niederndorferberg (AT)

Correspondence Address: NIXON & VANDERHYE, PC, 901 NORTH GLEBE ROAD, 11TH FLOOR, ARLINGTON, VA, 22203, US

(73) Assignee: KATHREIN-Austria Ges.m.b.H., Kufstein (AT)

(21) Appl. No.: 11/606,360

(22) Filed: Nov. 30, 2006

(30) Foreign Application Priority Data
Dec. 1, 2005 (DE) 102005057546.3-55

(51) Int. Cl. H04Q 5/22

(52) U.S. Cl. 340/10.34; 340/10.1; 340/572.7

(57) ABSTRACT

Contactless transmission of data for a number of information carriers uses a reader connected alternately at time intervals with a number of antennas, to send polling signals to information carriers and/or to receive information signals from the information carriers. If the connection between the reader and an antenna initially connected with the reader is broken, then simultaneously this antenna that has been disconnected from the reader is connected with at least one further energy source transmitter, in order to continue to supply the information carriers that are in the energy field of this antenna and which have already been read out and/or switched to “silent” or “inactive” with energy to maintain this state.

The invention concerns a method and a device for contactless transmission of data from a number of data carriers, in particular in the form of RFID-tags in accordance with the preamble of Claim 1 or 12.

Contactless identification systems with inductive energy and data transmission from a data transmitter/receiver device to a portable data carrier via a magnetic alternating field can, by way of example, be taken as known from DE 198 45 065 A1. The so-called radiofrequency identity or radiofrequency identification (RFID), in particular, involves the possibility of contactless reading out of information contained in portable data carriers. As a result the RFID method opens up a range of application possibilities, such as the possibilities of permanent checking if particular goods or products are available in stores during production processes or if particular goods with particular equipment features are available at particular locations.

RFID systems have a number of basic components and technical characteristics by which they are defined. In general a so-called reader is provided which is connected to an antenna. Via the antenna the reader sends out an appropriate polling signal. This signal, which is received by a tag, at the same time serves as the energy source to the tag. The corresponding information is read out from the tag and sent back to the transmitter/receiver device, the so-called reader, which receives the corresponding signal via the antenna and evaluates it. Here it is a case of a bidirectional transmission-reception path in the same frequency range or frequency band. In addition, in the various countries differing frequency bands may be approved for this method.

Apart from a substrate, in the form for example of an, if necessary, pliable film, these tags normally comprise a data carrier antenna and an associated circuit arrangement (or chip), in which the corresponding information is stored and which following receipt of a signal can be read out.

If a number of tags are present in the reading range of a RFID reader, then collisions during reading may occur. As a result, various anti-collision methods have previously been proposed in order to be able to perform the correct detection and reading out of various tags.

It is also known for the tag that has just been read to be switched to “silent” or “inactive” after reading. This function depends on the protocol and is in some cases automated by appropriate readers.

A tag that has been switched to silent or inactive remains inactive and silent until it is directly addressed again. Alternatively, such behavior is also, however, enabled by, for example, a corresponding tag being removed from an energy field, so that because the energy is no longer being received it is switched to silent or inactive. If the tag then enters a corresponding energy field again, for example that of a reader, then this automatically leads to a reset or a restart of the tag, with the result that the information stored on the tag can be read out again. If, for example, in a particular range, referred to in the following as a gate, for example on a conveyor belt, units with a number of tags are run or passed through, then normally in such an area several antennas will also be connected to a reader using the multiplex method. In such a case, however, there is a problem of reading out all the tags, in particular in respect of the reading out speed.

From the generic U.S. Pat. No. 5,995,019 A a method for contactless transmission of data is known, in which a polling signal is sent out by a reader via an antenna, in order to read out information from the individual RFID tags through receipt of an information signal sent out by the respective RFID tag. Here in order to read out the number of RFID tags at least two or more antennas are used. Furthermore, an RFID tag that has been read out is deactivated.

From U.S. Pat. No. 6,903,656 B1 a method for contactless transmission of data from a number of RFID tags is known, in which polling signals are sent out by a reader to RFID tags in order to read out information from the RFID tag by means of a number of antennas.

The object of the present invention is, therefore, on the basis of the generic prior art, to provide an improved method and an improved device for more rapid and more reliable reading out of a number of tags using at least two or more antennas.

This object is achieved concerning the method in accordance with Claim 1 and concerning the device in accordance with the characteristics indicated in Claim 12. Advantageous embodiments of the invention are indicated in the sub-claims.

The present invention provides a substantial improvement in the conventional method and the conventional devices.

To be specific, according to the invention, it is proposed that the tags present in the reading out range are permanently supplied with energy, so that they are always maintained in their current state. If the tags are switched to active, that is to say not yet read or read out, then they retain this state in the energy source range. If they have already been read out and have therefore been switched to “inactive” or “silent”, then they can retain this state through the additional energy source provided. This ensures that when switching the reading out of the tag from one antenna to the next the tags read out with the previously connected antenna are not switched off through the loss of the energy current via this antenna. Because this would have the effect that for a subsequent read-out cycle using the antenna that has previously had the energy switched off, all the tags would have to be reset again and therefore all tags would have to be read out again. In contrast to this the invention ensures that all tags are provided with a more or less permanent energy or tag source in that, for example, following the switching from one antenna to the next the antenna previously used for reading out the information on the tags is supplied with a separate energy source carrier frequency, so that the previously read out tags therefore continue (permanently) to be in an energy field. For this reason the previously read out tags following the reading out can continue to be maintained in the “inactive” or “silent” state, since a reset when the antenna is connected again for reading out these tags cannot take place. This ensures that all tags can be read out much more quickly and more reliably. Difficult to reach tags are in fact detected and read out only later (possibly only after a few multiplex cycles). Nevertheless, through the activation of these tags these tags specifically can still be detected and read out, since the tags already read out in the previous cycle continue to be constantly switched to “silent” or “inactive”.

Such an additional energy source must be provided at the latest following a switch from one antenna used for reading out of tags to another antenna. Preferably, however, when several antennas are used all or all other antennas are constantly fed with a carrier signal as the energy source for the tag, with the exception of those antennas via which active information is directly being read out from tags. Here it should be stated that basically also several readers can if necessary be provided with several antennas, which may simultaneously or at least to some extent simultaneously serve for the reading out of tags.

Preferably, the additional carriers provided, which in the following are also referred to as energy source transmitters, transmit at a frequency that is the same as or different from that of the reader. Normally the transmission frequency of the energy source carrier, however, will be within the frequency range specific to the country and which has been authorised and approved for these services.

Basically, the system according to the invention is also transferable to other frequency ranges.

Preferably, just one reader is used, along with a switching controller. By means of the switching controller the reader can in each case be connected alternately with one of a number of antennas. The switching device will preferably likewise ensure that the respective other antennas are then connected with the energy source transmitter.

The entire assembly can preferably be accommodated in a single housing. Alternatively, however, a modular assembly is possible with which a reader is used as an independent device or as a separate module alongside a switching control device and the energy source carrier.

The switching for establishing various connections between the reader and one of the number of antennas can take place in a number of ways, preferably cyclically with adjustable intervals, according to the random principle, protocol-dependent or controlled by the reader, or according to the condition of whether a particular tag has been read or a certain number of tags has been read. There are no restrictions in this respect.

The solution according to the invention, however, has the following further advantages, not only at the time of antenna switching, but also in particular when the entire system is connected for the first time. Here the starting point is the knowledge that via the antenna connected with the active reader only a proportion of all tags can be reached and supplied with energy. A residual number will be fully or partly supplied with energy via at least one additional antenna, namely via the additional energy source carrier provided in accordance with the invention. If it is considered here that the tags during the adjustment process require a certain amount of time until the required energy for operation is available (turn-on time), this means that following activation of the system all tags or a large proportion of all further tags are supplied with energy, namely also the tags that are located in the energy radiation field of the at least one additional antenna, which is fed with energy via the energy source carrier. The result of this is that the turning on of the remaining number of tags as well takes place in parallel with the read time and/or the write time of the tags that are located in the radiation field of the antenna connected to the active reader. This results in a certain time advantage, if the reader then wishes to read or write to the subsequent tags, which were previously in the radiation field of the at least one antenna, which were connected with the additional energy source carrier. This time advantage is achieved not only when the system is switched on, but also during each further multiplex cycle, since no further switching on of the tags is necessary as in each case these will previously have been supplied with energy via the energy source transmitter and the at least one additional antenna.

This time advantage then increases, inter alia, if:
the multiplex time slices are very short,
a large number of multiplex cycles exists, and/or
the tags are difficult to reach (which would lead to a longer turn-on time for these tags).

The invention is explained in more detail using drawings of an embodiment. These show, specifically, as follows:

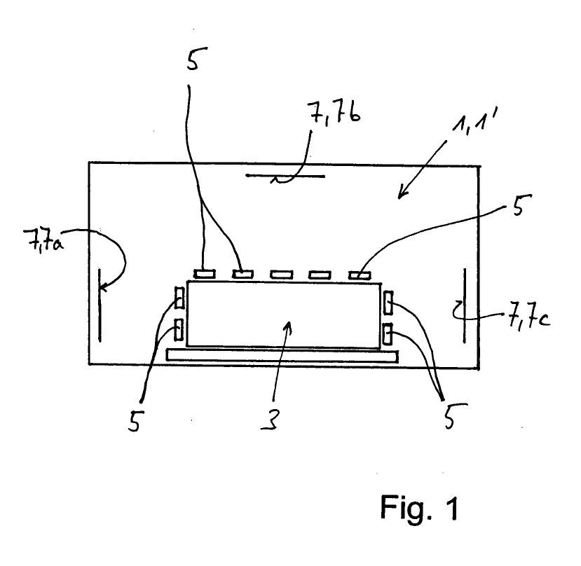

FIG. 1: is a schematic representation of a so-called gate, through which, by way of example a number of units, which are located on a conveyor belt, are passed, wherein in the embodiment shown three antennas are provided;

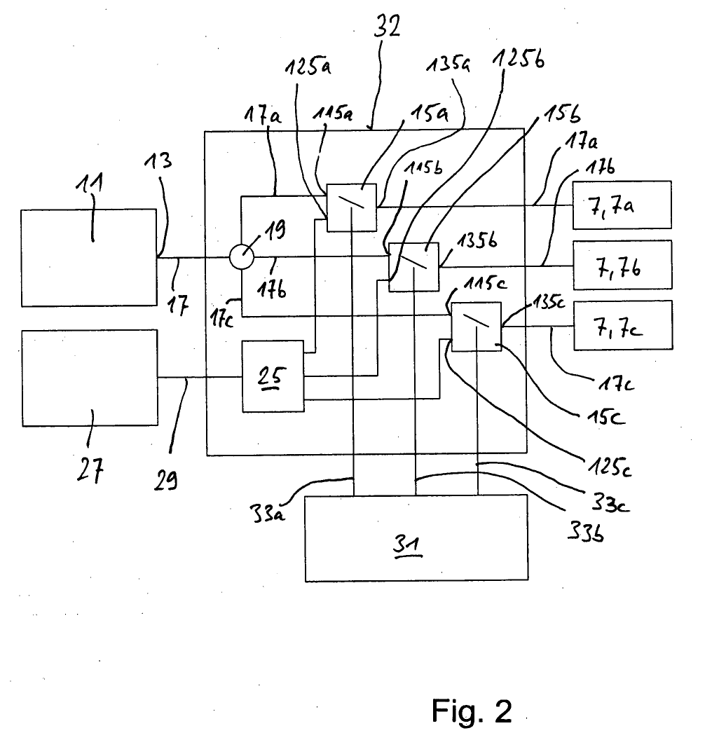

FIG. 2: is a schematic layout diagram to illustrate a laser system that has been expanded in accordance with the invention using three antennas.

FIG. 1 shows a schematic cross-section of a so-called gate 1, or generally a reading area 1′, through or against which a number of items 3 or products 3, etc., are passed. In the embodiment shown, by way of example, a number of items or products 3 are passed through this gate 1, which are provided with a number of information carriers 5, referred to for short as tags 5.

In the context of the method in question or the device in question tags 5 are used which are not provided with their own energy source. They are basically designed in such a way that they are provided with an integrated tag antenna, not shown in more detail, for receipt of signals from a reader with an integrated switching arrangement on a substrate, in which corresponding information is stored, which can be triggered in a known fashion by a reader.

In order for the tags to be able to transmit their information, they need energy which they receive via the signal transmitted from a reader.

In the embodiment shown the number of items 3 at various points are provided with tags 5 which make it necessary for the information present in these to be read out from various antennas 7, in the embodiment shown from the antennas 7a, 7b and/or 7c.

The further design is explained using FIG. 2.

FIG. 2, in turn, shows a reader 11, which by way of example transmits and/or receives in a frequency range of 865 MHz to 868 MHz. The transmission and reception channels are in the same frequency band or at the same frequency. At the same time, such a reader normally comprises an internal transmission or reception device with two paths and the associated energy source, wherein in this connection reference is made to known solutions.

A connection 13 to the reader 11, which for the transmission signals serves as an output and for the reception signals as an input, is not as normal connectable to a single antenna assigned to the reader 11 but, in the embodiment shown with the intermediate connection of switching devices 15, in each case with one of a number of antennas 7a to 7c. For this the connecting lead 17 runs from the connection 13 of the reader 11 to a branching point or a branch circuit 19, of the now three connecting leads 17a to 17c in each case to an input, i.e. in the embodiment shown an input 115a, 115b or 115c is in each case connected to a switching device 15a to 15c.

The switching devices 15 have a second input 125a to 125c, connected via a branch circuit 25 with an additional energy source transmitter 27 via a lead 29. It is a case here of an additional carrier, which by way of example transmits at a frequency of 868 MHz, preferably at a frequency in the same frequency band in which the reader also transmits or receives.

Finally, a switching controller 31 is also provided the switching leads 33a to 33c of which are connected with a control input of the switching devices 15a to 15c.

The three outputs 135a to 135c of the three switching devices 15a to 15c are connected via three antenna leads 17a to 17c with the three antennas 7a to 7c.

Said switching devices 15a to 15c, the branch point 19 and the branch circuit 25 and associated leads form a signal distribution device 32, which may if necessary also comprise the switching controller 31.

The method of functioning is dealt with below.

If, for example, the reader 11 is connected via the switching controller 31 and the subsequent first antenna lead 17 and 17a to the antenna 7a, then tags that are located in the range of antenna 7a or which can be read via it can be read out according to normal methods one after another and taking into consideration known collision methods.

During this the two further switching devices 15b and 15c are connected in such a way that in each case the energy source transmitter 27 is connected via the corresponding energy source leads and the second input 125b and 125c of the switching devices 15b and 15c and via the subsequent antenna leads 17b and 17c with the antennas 7b and 7c, via which the tags located at other points are supplied with energy.

In each case the tag from which information is read out via an antenna 7a and the reader 11 connected, is then switched to “inactive” or “silent”, in order to only further detect those tags in the energy source range of antenna 7a which have not yet been read out.

According to a particular method, for example the time multiplexing method, via the switching controller 31 the switching device can be switched in such a way that the reader 11 is connected via the second switching device 15b with the second antenna 7b. At the same time, however, the first switching device is switched to its second input, so that now the energy source transmitter 27 is connected via the first switching device 15a with the first antenna 7a. This ensures that the tags that have already been read and switched to “inactive” or “silent” continue to be supplied with energy and remain in this state. The connection between the energy source transmitter 27 and the third antenna 7c continues to be maintained here.

Then a further switching takes place, during which the reader is connected via the switching controller and the switching device 15c with the third antenna 7c. At the same time the second switching device 15b is likewise switched in such a way that the energy source transmitter 27 is not only connected via the first switching device 15a with the first antenna 7a, but simultaneously also via the second switching device 15b with the second antenna 7b, in order to supply the tags located in this catchment area with energy.

A corresponding read out can thus take place in several cycles, wherein through the further switching for example in turn the reader is connected with the first antenna and the energy source transmitter 27 with the second and third antennas and so on. Since, however, in the meantime the tags already read out via the first antenna have continued to be supplied with a carrier frequency with energy and as a result have continued to be in the “silent” or “inactive” switched state, any tags that are located in an unfavorable position or which have otherwise not yet been detected, or their information, can be read out more quickly and more reliably, since no repeat read out of all the tags has to take place.

The entire switching can thus be continued permanently in several cycles so that in this way more quickly and more reliably as a rule all tags can be read out without a double readout taking place.

The following description shows, however, that in connection with the invention advantages, above all time advantages, arise if multiplex time slices for successive polling of tags are very short, there is a high number of multiplex cycles, and/or at least some tags are difficult to reach, so that longer turn-on times for reading out or writing the tags are necessary.

In order to better understand the time advantages, in the following it is assumed that the quantity of all tags can be subdivided into a quantity that can be reached directly by the active reader, thus the connected reader 11 and the associated antenna. This part quantity of tags supplied with energy via the reader and the connected antenna is in the following referred to as quantity M1.

Furthermore, there is another quantity of tags M2, which can, generally speaking, be reached and supplied with energy via all the other antennas which are connected with the energy source transmitter 27. The total quantity of all tags is thus the quantity M1+quantity M2. After each multiplexing procedure the above quantities will be different.

During the turn-on time the tags require a certain time until they have the necessary energy for operation available (turn-on time). Following activation of the system as a whole, thus after the reader and the additional energy source transmitter 27 have been connected, all tags are supplied with energy simultaneously or within a very short space of time, including those tags which belong to quantity M2, thus via the additional energy source carrier. (Wherein for the following consideration it would be sufficient if of this quantity only a partial quantity were to be supplied with additional energy via the energy source carrier). The result of this is that the turning-on of the tags from quantity M2 takes place during the read time and/or the write time of the tags from M1. This results in a certain time advantage, if the reader and the antenna connected via it is switched in order now to read out or write tags that belong to quantity M2 in a next step, thus if a new multiplex cycle is carried out. For the new tags to be read out or written have already been “turned on” by the previously provided energy source, so that a turn-on time that would otherwise prove to be a disadvantage is dispensed with. This time advantage is therefore not only obtained when the system as a whole is firstly turned on, but for each further multiplexing cycle.

The entire arrangement can have a modular design, thus comprising reader, additional energy source transmitter, switching controller as well as individual switching device and antenna modules. With the exception of the antennas the arrangement can be designed as an integrated construction, in which the layout, with the exception of the antennas, is accommodated in a shared housing. In some circumstances, however, the antennas can also be integrated in a suitably designed housing which, for example, comprises a gate.

The actual switching that has been explained does not have to take place cyclically. However, it is preferable if it takes place cyclically, for example with an adjustable or definable interval, wherein for several successive cycles the periods over which the tags are read out via an antenna can if necessary also be set differently or even changed in the course of several cycles. Likewise, however, the reading out can also be based on the random principle, or under the control of the reader or according to a protocol. For example, basically a switch to another antenna can be made if, for example, a tag or a specific quantity of tags has been newly read out.

1. A method for contactless transmission of data from a number of data or information carriers comprising:
transmitting a polling signal by a reader via an antenna connected to the reader to one or more information carriers,
reading out of information from an individual information carrier by receipt of an information signal transmitted by the one or more information carriers and received by an antenna,
switching a read information carrier to “silent” or “inactive” once its information has been read out, and
using at least two antennas to read out the number of information carriers,
wherein:
the reader is connected alternately at time intervals in each case with another of the number of antennas, to send polling signals to information carriers and/or to receive information signals from the information carriers concerned, and
if the connection between the reader and an antenna initially connected with the reader is broken, then simultaneously said antenna that has been disconnected from the reader is connected with at least one further energy source transmitter, in order to continue to supply the information carriers, which are in the energy field of this antenna and which have already been read out and/or switched to “silent” or “inactive”, with energy to maintain said state.

2. The method as claimed in claim 1, wherein all antennas, which are connected with the reader in the time interval, for the times for which they are disconnected from the reader, are connected with the energy source transmitter, in order to maintain the information carriers located in the energy field of this antenna or these antennas and switched to the “silent” or “inactive” state in this state.

3. The method as claimed in claim 1, wherein the switching of the reader for the successive setting up of a connection between the reader and a respective other of the number of antennas and the corresponding connection of the at least one energy source transmitter with the other antennas not connected with the reader takes place cyclically.

4. The method as claimed in any one of claim 1, wherein the switching of the reader for the successive setting up of a connection between the reader and a respective other of the number of antennas and the corresponding connection of the at least one energy source transmitter with the other antennas not connected with the reader takes place cyclically with adjustable or changeable intervals.

5. The method as claimed in claim 1, wherein the switching of the reader for the successive setting up of a connection between the reader and a respective other of the number of antennas and the corresponding connection of the at least one energy source transmitter with the other antennas not connected with the reader takes place using the time multiplex method.

6. The method as claimed in claim 1, wherein the switching of the reader for the successive setting up of a connection between the reader and a respective other of the number of antennas and the corresponding connection of the at least one energy source transmitter with the other antennas not connected with the reader takes place according to a random principle.

7. The method as claimed in claim 1, wherein the switching of the reader for the successive setting up of a connection between the reader and a respective other of the number of antennas and the corresponding connection of the at least one energy source transmitter with the other antennas not connected with the reader takes place under the control of the reader and/or according to a protocol, preferably depending on whether at least one further information carrier has been read out.

8. The method as claimed in claim 1, wherein one of the quantity of switching devices corresponding to the quantity of antennas is used, the two inputs of which are at least directly connected with the reader or the energy source transmitter, wherein by using a switching controller in each case only one of the two inputs is connected with an antenna lead connected with an antenna connected in series.

9. The method as claimed in claim 1, wherein the reader and the at least one additional energy source transmitter work in the same frequency band or the frequency used by the energy source transmitter is within a frequency band used by the reader.

10. The method as claimed in claim 1, wherein at least part of the information carriers and preferably all the information carriers, which are not located in the energy field of the antenna, which is connected to the active reader, are supplied with energy via the at least one more of the number of antennas that is connected to the energy source transmitter.

11. The method as claimed in claim 10, wherein the turning on or off of the system as a whole takes place via the antenna connected with the reader and preferably simultaneously or within a short space of time or within a pre-selectable time window, which is preferably smaller than a multiplex cycle, including via the at least one more of the number of antennas that is connected to the energy source transmitter.

12. A device for contactless transmission of data from a number of data or information carriers, preferably in the form of RFID tags, comprising:
plural antennas,
a reader connected or connectable to said antenna, via which polling signals can be sent to at least one information carrier,
the information carrier, containing information, and which following receipt of an electromagnetic signal that serves as the power source, reads out corresponding information and sends this to an antenna for evaluation at the connected reader,
a switch that switches said information carrier that has been read out to “silent” or “inactive”,
a signal distribution device, the signal distribution device comprising at least two switching devices,
the switching device connecting the reader for a specific, preferably cyclically repeating time phase with one of the plural antennas,
the switching device connecting the reader with another of the plural antennas,
an energy source transmitter, and
the antenna, which following the switching of the reader to another antenna was last connected with the reader, is connected with the energy source transmitter, in order to maintain the information carriers located in the energy field of this antenna or these antennas and switched to the “silent” or “inactive” state in this state.

13. The device as claimed in claim 12, wherein via the switching devices in the interval of time all antennas are connected in any and preferably a cyclical sequence with the reader, and in that all other antennas that are not connected with the reader for specific periods are connected with the at least one energy source transmitter for radiation of electromagnetic energy.

14. The device as claimed in claim 12, wherein a switching controller is provided, via which the switching devices can be driven.

15. The device as claimed in claim 12, wherein the switching devices have at least two inputs, wherein in each case one input is preferably connected via a branch circuit with the reader and the other input is preferably connected via a branch circuit with the energy source transmitter.

16. The device as claimed in claim 15, wherein the switching devices have at least one further control input which is connected with the switching controller.

17. The device as claimed in claim 12, wherein the switching device has at least one output which is connected with at least one input of an assigned antenna.

18. The device as claimed in claim 12, wherein the device has a modular design.

19. The device as claimed in claim 1, wherein the switching devices and preferably the signal distribution device driving the switching device and preferably the reader and in particular the energy source transmitter are designed as a handy single unit.

20. The device as claimed in claim 1, wherein the signal distribution device and/or the switching controller is/are constructed in such a way that the switching of the reader for successive creation of a connection between the reader and in each case another antenna and the corresponding connection of the at least one energy source transmitter with the other antennas not connected with the reader, takes place cyclically.

21. The device as claimed in claim 1, wherein the signal distribution device and/or the switching controller are constructed in such a way that the switching of the reader for successive creation of a connection between the reader and in each case another of the number of antennas and the corresponding connection of the at least one energy source transmitter with the other antennas not connected with the reader, takes place cyclically with adjustable and/or variable intervals.

22. The device as claimed in claim 1, wherein the signal distribution device and/or the switching controller are constructed in such a way that the switching of the reader for successive creation of a connection between the reader and in each case another of the number of antennas and the corresponding connection of the at least one energy source transmitter with the other antennas not connected with the reader, takes place using the time multiplex method.

23. The device as claimed in claim 12, wherein the signal distribution device and/or the switching controller are constructed in such a way that the switching of the reader for successive creation of a connection between the reader and in each case another of the number of antennas and the corresponding connection of the at least one energy source transmitter with the other antennas not connected with the reader, takes place according to a random principle.

24. The device as claimed in claim 12, wherein the signal distribution device and/or the switching controller are constructed in such a way that the switching of the reader for successive creation of a connection between the reader and in each case another of the number of antennas and the corresponding connection of the at least one energy source transmitter with the other antennas not connected with the reader, takes place under the control of the reader and/or according to a protocol, preferably according to whether at least one further information carrier has been read out.

25. The device as claimed in claim 12, wherein the energy source transmitter transmits at a frequency which corresponds to a frequency at which the reader transmits and/or receives, or which at least represents a frequency in a frequency band in which the reader transmits and/or receives.

26. The device as claimed in claim 12, wherein the reader and the antenna connected via this and the energy source transmitter can be connected to or brought into circuit with at least one further of the number of antennas associated with it simultaneously or preferably within an adjustable or pre-selectable time window, which is preferably smaller than the duration of a multiplex cycle.
